(19) United States
(12) Patent Application Publication
(10) Pub. No.: US 2012/0028790 A1
(43) Pub. Date: Feb. 2, 2012

(54) NON-PLATINUM OXYGEN REDUCTION CATALYSTS FOR POLYMER ELECTROLYTE MEMBRANE FUEL CELL AND METHOD FOR PREPARING THE SAME

(75) Inventors: Bum Wook Roh, Gyeonggi-do (KR); Il Hee Cho, Seoul (KR); Nak Hyun Kwon, Seoul (KR); Han Sung Kim, Seoul (KR); Hyung-Suk Oh, Incheon (KR)

(73) Assignees: INDUSTRY-ACADEMIC COOPERATION FOUNDATION, YOUNSEI UNIVERSITY, Seoul (KR); HYUNDAI MOTOR COMPANY, Seoul (KR)

(21) Appl. No.: 12/955,289

(22) Filed: Nov. 29, 2010

(30) Foreign Application Priority Data
Jul. 30, 2010 (KR) 10-2010-0074074

(51) Int. Cl. B01J 31/16; B01J 37/12; B01J 37/08; B01J 37/02; B82Y 30/00

(52) U.S. Cl. 502/159; 977/742

(57) ABSTRACT

Provided are a non-platinum oxygen reduction catalyst for a polymer electrolyte membrane fuel cell and a method for preparing the same. More particularly, an oxygen reduction catalyst in which chelated cobalt is impregnated on a conductive polymer coated on a carbon support and a method for preparing the oxygen reduction catalyst by coating a conductive polymer on a carbon support, impregnating chelated cobalt on the conductive polymer and then treating the same with heat and an acid are disclosed. The platinum-free oxygen reduction catalyst of the present invention has superior oxygen reduction activity and durability with high proportion of pyridinic and graphitic nitrogens on the catalyst surface, and thus can be usefully applied for a polymer electrolyte membrane fuel cell.

### CROSS-REFERENCE TO RELATED APPLICATIONS

This application claims priority under 35 U.S.C. §119 to Korean Patent Application No. 10-2010-0074074, filed on Jul. 30, 2010, in the Korean Intellectual Property Office, the disclosure of which is incorporated herein by reference in its entirety.

### BACKGROUND

(a) Technical Field

The present disclosure generally relates to a non-platinum oxygen reduction catalyst for a polymer electrolyte membrane fuel cell and a method for preparing the same.

(b) Background Art

Fuel cells that directly convert chemical energy, produced from oxidation of a fuel, into electrical energy have been spotlighted as a next-generation energy source. In particular, research for commercialization of fuel cells in the automobile industry has been actively carried out due to its potential to provide improved fuel efficiency, reduced emission, environmental friendliness and other advantages.

Because a polymer electrolyte membrane fuel cell is operated at low temperature, a platinum catalyst is typically used for the anode and cathode of the fuel cell in order to improve reaction rate. However, platinum is expensive and its reserves are very limited. About 50 g of platinum is required to produce a hydrogen fuel cell car using a polymer electrolyte membrane fuel cell. Thus, for example, for the annual manufacture of 70 million cars, 3,500 tons of platinum would be required. However, the present annual production of platinum is only about 180 tons, and the reserves of platinum are estimated at only about 36,000 tons. Further, the price of platinum is presently about 65,000 Korean won (about $55 U.S. dollars) per gram, and thus more than 3.25 million Korean won (approximately $2850 U.S. dollars) worth of platinum is required to produce a single car. In addition, the procedure for forming platinum complexes and processing into ultrafine particles of 2 to 3 nm through pyrolysis or the like further increases the manufacturing cost considerably. Thus, there is an urgent need for the development of an oxygen reduction catalyst capable of replacing platinum.

The traditional research on non-platinum oxygen reduction catalysts for fuel cells has been mainly focused on increasing oxygen reduction activity and improving stability in an acidic atmosphere. Porphyrin-based macrocycles bound to a transition metal have been studied as a potential non-platinum catalyst. Examples of the macrocycle catalyst include iron phthalocyanine and cobalt methoxytetraphenylporphyrin which are disclosed, for example, in Korean Patent Application Publication No. 10-2007-0035710. However, while the macrocycle materials have good oxygen reduction activity, they are unstable in acidic atmospheres and are also very expensive. Most macrocycles have a structure of MN₄ with nitrogen atoms bound to a central transition metal. In an attempt to mimic this structure, a method has been proposed for preparing nitrogen-doped transition metal catalysts by reacting ammonia at high temperature with a transition metal. Similarly, the Popov group of the University of South Carolina prepared a new non-platinum catalyst by reacting urea and ethylenediamine with a transition metal to prepare a chelate compound, impregnating the same on a carbon support and then forming carbon-nitrogen bonds through heat treatment. However, this attempt was not satisfactory in terms of oxygen reduction activity and stability. Further, Zelenay and others of the Los Alamos National Laboratory prepared a non-platinum catalyst wherein cobalt is bound to polypyrrole. However, although stability was significantly improved in an acidic atmosphere, oxygen reduction activity was not sufficiently high.

There have further been studies on chalcogenide-based non-platinum catalysts like MoRuSe (as disclosed in U.S. Patent Publication No. 2004/0236157) and oxide-based non-platinum catalysts such as tungsten oxide. However, it is reported that these materials have lower activity than the macrocycle-based non-platinum catalysts.

Accordingly, there is a need for the development of new non-platinum catalysts with satisfactory oxygen reduction activity and stability.

### SUMMARY

The present invention generally provides a non-platinum catalyst having good oxygen reduction activity and excellent durability in an acidic atmosphere, and a method for preparing the same.

In particular, the present inventors found that a non-platinum catalyst having good oxygen reduction activity and durability in an acidic atmosphere can be prepared by coating a conductive polymer on a carbon support and then introducing chelated cobalt thereto.

In accordance with one embodiment of the present invention, an oxygen reduction catalyst with chelated cobalt impregnated on a conductive polymer coated on a carbon support is provided.

According to another embodiment of the present invention a method is provided for preparing an oxygen reduction catalyst, wherein the method includes: adding a carbon support and 1-pyrenecarboxylic acid to ethanol to prepare a first mixture solution; adding an oxidizing agent and pyrrole or aniline to the first mixture solution to prepare a carbon support coated with a conductive polymer; adding a cobalt precursor and a chelating agent to ethanol to prepare a second mixture solution; adding the carbon support coated with the conductive polymer to the second mixture solution to prepare an intermediate, wherein chelated cobalt is impregnated on the conductive polymer; heat treating the intermediate at a suitable temperature (e.g., about 700 to 900° C.); and treating the heat-treated intermediate with an acid.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other aspects and features of the present disclosure will be infra.

### BRIEF DESCRIPTION OF THE DRAWINGS

The above and other objects, features and advantages of the present disclosure will now be described in detail with reference to certain exemplary embodiments thereof illustrated in the accompanying drawings which are given hereinbelow by way of illustration only, and thus are not limitative of the disclosure, and wherein:

FIG. 1 shows nitrogens bound on the surface of an oxygen reduction catalyst according to an embodiment of the present invention;

FIG. 2 schematically illustrates protonation of pyridinic nitrogen on the carbon surface after prolonged operation of a non-platinum oxygen reduction catalyst;

FIG. 3 shows high-resolution transmission electron microscopic (HRTEM) images of polypyrrole-coated carbon nanofiber [(a), (b)] and the oxygen reduction catalyst [(c), (d)] prepared in the Example;

FIG. 4 shows a result of evaluating oxygen reduction activity of an oxygen reduction catalyst (Co-ED/PPy-CNF catalyst) during the preparation thereof in the Example (Raw: carbon nanofiber, Step-1: polypyrrole-coated carbon nanofiber, Step-2: heat-treated Co-ED/PPy-CNF catalyst, Step-3: acid-treated Co-ED/PPy-CNF catalyst);

FIG. 5 shows a result of evaluating oxygen reduction activity of the catalysts prepared in the Example and in Comparative Examples 1 and 2;

FIG. 6 shows a result of evaluating single-cell oxygen consumption of the Co-ED/PPy-CNF catalyst prepared in the Example, as it depends on coating amount;

FIG. 7 shows a result of evaluating single-cell oxygen consumption of the catalysts prepared in the Example and in Comparative Examples 1 and 2;

FIG. 8 shows N1s X-ray photoelectron spectroscopic (XPS) spectra of the catalysts prepared in the Example and in Comparative Examples 1 and 2; and

FIG. 9 shows a result of evaluating single-cell durability of the catalysts prepared in the Example and in Comparative Examples 1 and 2.

It should be understood that the appended drawings are not necessarily to scale, presenting a somewhat simplified representation of various preferred features illustrative of the basic principles of the disclosure. The specific design features of the disclosure as disclosed herein, including, for example, specific dimensions, orientations, locations and shapes, will be determined in part by the particular intended application and use environment.

### DETAILED DESCRIPTION

Hereinafter, reference will now be made in detail to various embodiments of the present disclosure, examples of which are illustrated in the accompanying drawings and described below. While the disclosure will be described in conjunction with exemplary embodiments, it will be understood that the present description is not intended to limit the disclosure to those exemplary embodiments. On the contrary, the disclosure is intended to cover not only the exemplary embodiments, but also various alternatives, modifications, equivalents and other embodiments, which may be included within the spirit and scope of the disclosure as defined by the appended claims.

The present invention provides an oxygen reduction catalyst, particularly an oxygen reduction catalyst with chelated cobalt impregnated on a conductive polymer coated on a carbon support.

The carbon support may be any support used for existing catalysts and is not especially limited. Some preferred carbon supports can be selected from, but are not limited to, one or more amorphous carbon black or crystalline carbon nanotube, carbon nanofiber, carbon nanocoil and carbon nanocage. The conductive polymer is also not particularly limited and may be, for example, nitrogen-containing polypyrrole or polyaniline. The conductive polymer may be coated on the carbon support by any known methods, such as, for example, dispersing the support in ethanol and adding pyrrole or aniline along with an oxidizing agent, so that polymerization may occur on the support surface.

According to the present invention, the chelated cobalt may be obtained, for example, by adding a cobalt precursor and a chelating agent to ethanol and then stirring the resulting mixture. The cobalt precursor is not particularly limited, and may be, for example, one or more selected from the group consisting of cobalt-containing oxide, acetate, nitrate and sulfate. In an exemplary embodiment, the nitrate Co(NO₃)₂.6H₂O may be used. The chelating agent is also not particularly limited, and may be, for example, one having two or more nitrogens and two or more carbon chains. Specific examples of chelating agents include, but are not limited to, ethylenediamine and 1,3-diaminopropane.

The oxygen reduction catalyst may be prepared in accordance with any known methods. According to a preferred embodiment, the present oxygen reduction catalyst is prepared by impregnating the chelated cobalt on the conductive polymer which is coated on the carbon support, and followed by heat treatment and acid treatment.

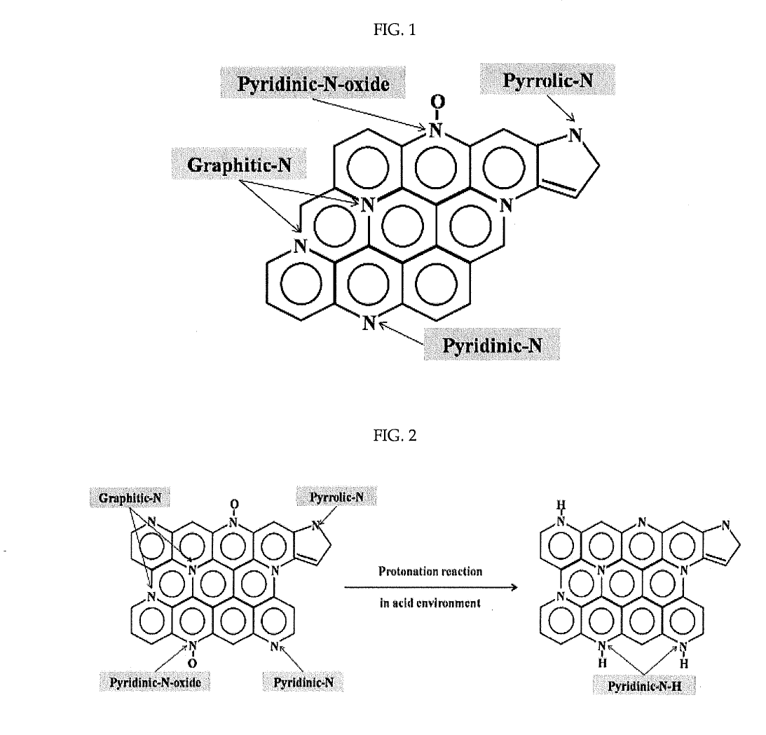

FIG. 1 shows nitrogens bound on the surface of an oxygen reduction catalyst according to an embodiment of the present invention. In particular, the nitrogens are distinguished as pyridinic, graphitic or pyrrolic nitrogens depending on their binding positions. Such carbon-nitrogen structures are known as reaction sites of oxygen reduction. Among these structures, pyrrolic is known to be nonreactive, while pyridinic and graphitic are known to be highly reactive. As such, oxygen reduction activity may be improved by increasing those nitrogens having higher activity.

FIG. 2 schematically illustrates protonation of pyridinic nitrogen on the carbon surface after prolonged operation of a non-platinum oxygen reduction catalyst. According to Electrochemica Acta 55 (2010) 2853, protonation of pyridinic nitrogen is related to the durability of a non-platinum catalyst. A non-platinum catalyst has superior oxygen reduction activity when it has high proportion of pyridinic and graphitic nitrogens on the catalyst. However, as pyridinic nitrogen is protonated in the course of prolonged operation of a fuel cell, the catalyst loses its activity. Thus, a non-platinum catalyst having a high proportion of graphitic nitrogen has good durability. The oxygen reduction catalyst of the present invention has a remarkably higher proportion of graphitic nitrogen than existing non-platinum catalysts and, thus, has superior oxygen reduction activity and durability as compared to the existing catalysts.

According to another embodiment of the present invention, a method for preparing the non-platinum oxygen reduction catalyst is provided which comprises: adding a carbon support and an acid, preferably 1-pyrenecarboxylic acid, to an alcohol, preferably ethanol, to prepare a first mixture solution; adding an oxidizing agent and pyrrole or aniline to the first mixture solution to prepare a carbon support coated with a conductive polymer; adding a cobalt precursor and a chelating agent to an alcohol, preferably ethanol, to prepare a second mixture solution; adding the carbon support coated with the conductive polymer to the second mixture solution to prepare an intermediate, wherein chelated cobalt is impregnated on the conductive polymer; heat treating the intermediate at a suitable temperature (e.g. 700 to 900° C.); and treating the heat-treated intermediate with an acid.

When adding the carbon support and acid (e.g., 1-pyrenecarboxylic acid) to alcohol (e.g. ethanol) to prepare the first mixture solution, the carbon support may be carbon black, carbon nanotube, carbon nanofiber, carbon nanocoil, carbon nanocage, or the like as described above. 1-Pyrenecarboxylic acid is preferably used to improve hydrophilicity of the support by forming π-π interactions between pyrene and the graphene of the carbon support. 1-Pyrenecarboxylic acid may be used in a suitable amount, preferably 40 to 60 parts by weight based on 100 parts by weight of the carbon support. If the amount of 1-pyrenecarboxylic acid is too small, the carbon support may have insufficient hydrophilicity. Further, if 1-pyrenecarboxylic acid is used in an excessively large amount, the resulting effect is not comparatively large.

As the oxidizing agent and pyrrole or aniline are added to the first mixture solution to prepare the carbon support coated with the conductive polymer, pyrrole or aniline is polymerized on the carbon support into polypyrrole or polyaniline. The pyrrole or aniline may be added in a suitable amount, preferably 80 to 130 parts by weight based on 100 parts by weight of the carbon support. If the added amount of pyrrole or aniline is less than 80 parts by weight, catalyst durability may be degraded because the support is not sufficiently coated with the conductive polymer. Further, if the added amount exceeds 130 parts by weight, the conductive polymer is not further coated beyond a certain coating thickness. The oxidizing agent is not particularly limited and, for example, may be one or more selected from the group consisting of ammonium persulfate, iron(II) chloride and potassium dichromate. In one preferred embodiment, ammonium persulfate is used. The oxidizing agent may be added in a suitable amount, such as 0.2 to 0.4 wt % relative to the amount of the pyrrole or aniline. If the added amount of oxidizing agent is too small, polymerization of polypyrrole or polyaniline may be insufficient and the carbon support may not be sufficiently coated with the conductive polymer. On the other hand, if the added amount is too large, the oxidizing agent remaining after the polymerization may act as an impurity and reduce the activity of the non-platinum catalyst. The polymerization may be performed at suitable temperatures, such as from 3 to 25° C. If the polymerization temperature is below 3° C. or above 25° C., the conductive polymer may not be coated as desired.

As the cobalt precursor and the chelating agent are added to ethanol to prepare the second mixture solution, the chelated cobalt is prepared. The cobalt precursor is not particularly limited and may, for example, be one or more selected from the group consisting of cobalt-containing oxide, acetate, nitrate and sulfate, and the chelating agent may be one having two or more nitrogens and two or more carbon chains, such as ethylenediamine and 1,3-diaminopropane. A suitable weight proportion of the cobalt precursor to the chelating agent is used, preferably be 1:1-20. If the added amount of the chelating agent is too small, the chelated cobalt may not be formed as desired and thus the activity of the non-platinum catalyst may be insufficient. On the other hand, if the added amount is too large, preparation and recovery of the catalyst may be difficult because increased viscosity and catalyst activity may be degraded because uniform heat treatment is difficult.

The carbon support coated with the conductive polymer is then added to the second mixture solution to prepare the intermediate wherein chelated cobalt is impregnated on the conductive polymer. The added amount of the carbon support coated with the conductive polymer may be adjusted to appropriate amounts such that 5 to 20 wt % of cobalt is supported. If the added amount is too small, the amount of the chelated cobalt impregnated in unit surface area of the catalyst is too large such that, even after the subsequent acid treatment, the remaining cobalt may be dissolved and leaked out during the operation of the fuel cell. On the other hand, if the added amount is too large, performance of the non-platinum catalyst may decrease because the active sites for oxygen reduction decrease. The impregnation may be performed at suitable temperatures, preferably 75 to 90° C., preferably under reflux. If the impregnation temperature is below 75° C., the chelated cobalt may not be easily impregnated on the support. On the other hand, if the impregnation temperature is above 90° C., the activity of the non-platinum catalyst may decrease because cobalt is reduced before the heat treatment.

The intermediate obtained by impregnating the chelated cobalt on the conductive polymer is then recovered in the form of powder by evaporating the solvent and is then subjected to heat treatment at suitable temperature, preferably 700 to 900° C. Through the heat treatment, pyridinic, graphitic and pyrrolic nitrogen groups are formed on the carbon support. The heat treatment may be performed in an atmosphere of an inert gas such as argon. In some embodiments, 10 vol % or less of hydrogen may be included. If the heat treatment is below 700° C., pyrrolic nitrogens may not be easily converted to pyridinic and graphitic nitrogens because the pyrolysis of the conductive polymer and the chelate compound is insufficient, which results in reduced activity of the non-platinum catalyst. On the other hand, if the heat treatment is above 900° C., the activity of the non-platinum catalyst may decrease because the nitrogen content of the non-platinum catalyst decreases.

Following the heat treatment, acid treatment is performed to remove the excessively impregnated cobalt. Since the excessive cobalt reduces performance of a fuel cell as it is dissolved and leaks out during the operation of the fuel cell, it is preferably removed, for example by dissolving with an acid. The acid treatment may be performed at suitable temperature, such as 75 to 90° C., using an appropriate solution, such as a 0.3-0.8 M aqueous solution of hydrochloric acid, nitric acid or sulfuric acid. If the aqueous solution is too dilute or if the treatment temperature is too low, the excessive cobalt may not be removed and the performance of the fuel cell may be decreased. On the other hand, if the concentration is too high or if the treatment temperature is too high, pyridinic nitrogen may be protonated and, as a result, the performance of the non-platinum catalyst may decrease.

After the acid treatment, the remaining solid is sufficiently washed with water and then dried to recover the oxygen reduction catalyst in powder form.

Since the non-platinum oxygen reduction catalyst according to the present invention has superior catalyst durability in an acidic atmosphere and has high oxygen reduction activity, it may be beneficially applied, for example, to a polymer electrolyte membrane fuel cell.

### EXAMPLES

The examples and experiments will now be described. The following examples and experiments are for illustrative purposes only and not intended to limit the scope of this disclosure.

### Example

### Preparation of Co-ED/PPy-CNF Catalyst in Accordance with the Present Invention

1-Pyrenecarboxylic acid (250 mg) was added to ethanol (400 mL) and stirred for 30 minutes. Herringbone type carbon nanofiber (500 mg) was then added to the 1-pyrenecarboxylic acid solution and stirred for 6 hours. Pyrrole monomer (500 mg) was then added and stirred at 4° C. for 1 hour. Next, an oxidizing agent ammonium persulfate (228 mg) was dissolved in water (100 mL) to prepare an aqueous solution. The ammonium persulfate aqueous solution (67.75 mL) was put in a reactor and stirred at 4° C. for 24 hours so as to obtain a coated support with polypyrrole polymerized on the carbon nanofiber surface. Upon completion of the polymerization, the resulting solid was recovered by filtration under reduced pressure, washed sufficiently using water and ethanol, and dried in a vacuum oven of 40° C. for 12 hours. Thus, polypyrrole-coated carbon nanofiber was obtained.

Co(NO₃)₂.6H₂O (297.2 mg) was added to ethanol. After adding ethylenediamine (375 mg) and sufficiently stirring to form chelated cobalt, the polypyrrole-coated carbon nanofiber (500 mg) was added and refluxing was carried out at 80° C. for 3 hours. Upon completion of the refluxing, the solvent was evaporated using an evaporator so as to recover an intermediate with the chelated cobalt impregnated on a conductive polymer.

The recovered intermediate was heat treated for 1 hour in a furnace at 800° C. under an argon atmosphere. Then, the heat-treated intermediate was put in 0.5 M sulfuric acid and refluxing was carried out at 80° C. for 3 hours to dissolve excessive cobalt. Thereafter, the remaining solid was sufficiently washed with water and an oxygen reduction catalyst (Co-ED/PPy-CNF catalyst) was obtained in powder form by filtration under reduced pressure.

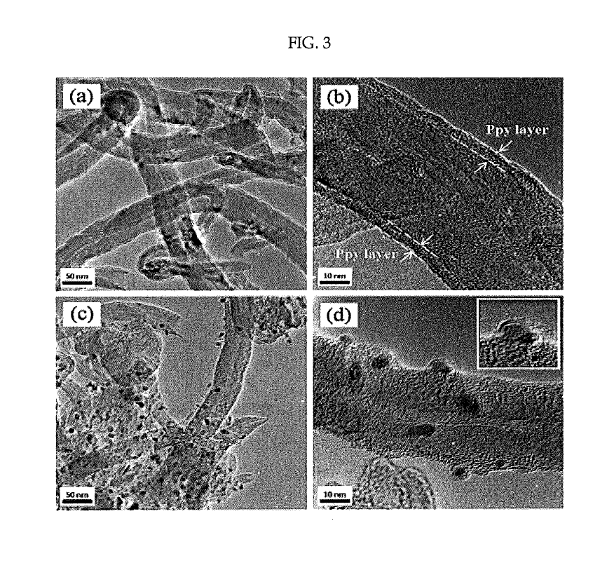

FIG. 3 shows high-resolution transmission electron microscopic (HRTEM) images of the polypyrrole-coated carbon nanofiber [(a), (b)] and the oxygen reduction catalyst [(c), (d)] prepared in the Example. It is shown in (a) and (b) that polypyrrole is coated with a thickness of 5 nm on the surface of the carbon nanofiber. Also, cobalt particles of 5 to 8 nm are observed in (c) and (d).

### Comparative Example 1

### Preparation of Co-ED/CNF Catalyst

A Co-ED/CNF catalyst was prepared in the same manner as the above Example except for impregnating chelated cobalt directly on carbon nanofiber and without coating the carbon nanofiber with polypyrrole.

### Comparative Example 2

### Preparation of Co/PPy-CNF Catalyst

A Co/PPy-CNF catalyst was prepared in the same manner as the above Example except for impregnating cobalt on polypyrrole-coated carbon nanofiber and without chelating cobalt.

### Test Example

### Measurement of Physical Properties

1) Evaluation of Oxygen Reduction Activity

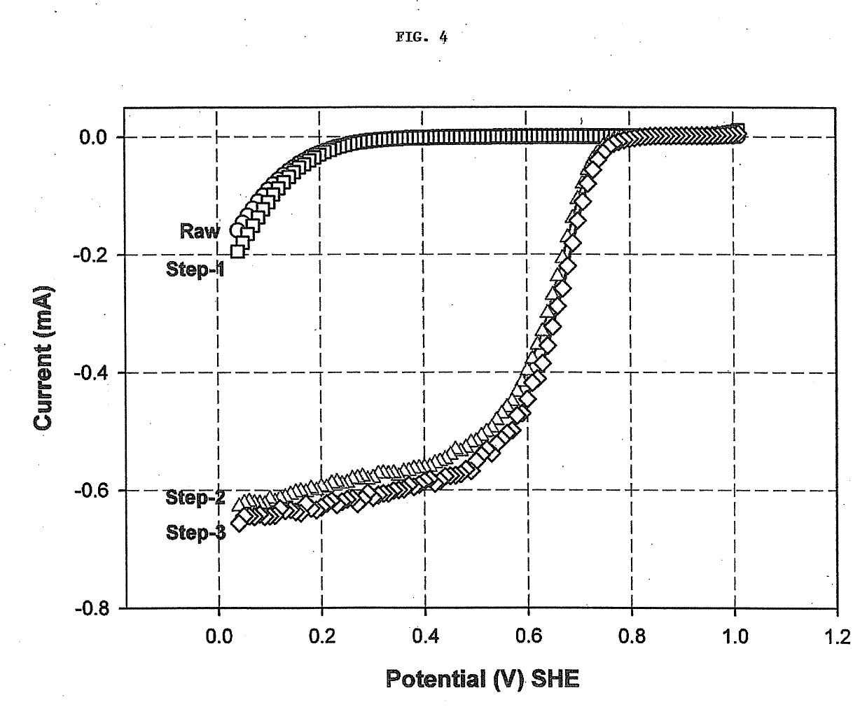

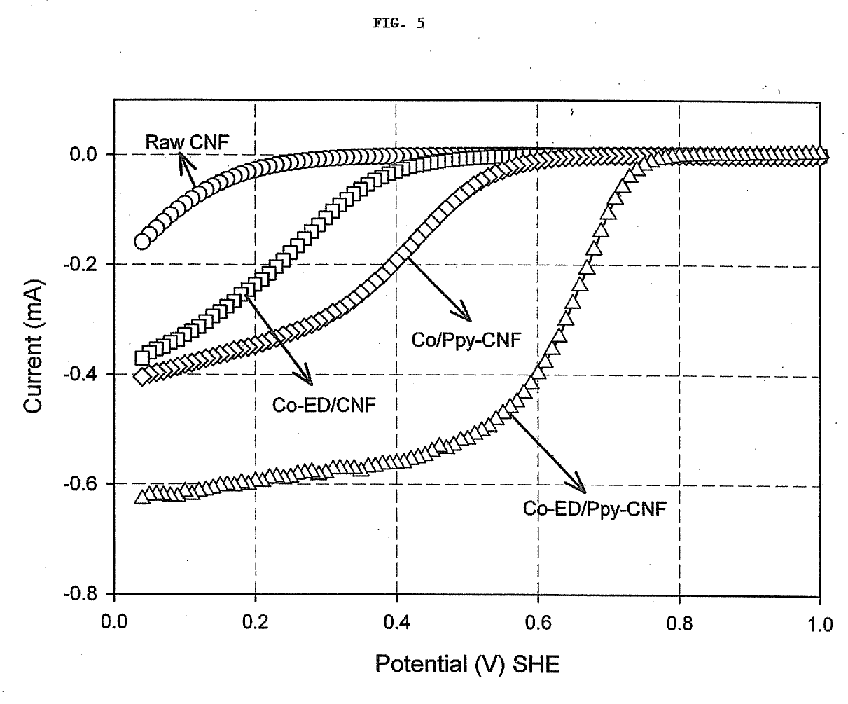

Oxygen reduction activity of the oxygen reduction catalyst (Co-ED/PPy-CNF catalyst) was evaluated using a rotating ring-disk electrode (RRDE) during the preparation thereof in the Example. The evaluated samples were carbon nanofiber (Raw), polypyrrole-coated carbon nanofiber (Step-1), heat-treated Co-ED/PPy-CNF catalyst (Step-2), and acid-treated Co-ED/PPy-CNF catalyst (Step-3). Oxygen reduction activity was also measured for the catalysts prepared in Comparative Examples 1 and 2. The results are shown in FIGS. 4 and 5.

The potential at which the reduction current begins to flow is called the onset potential. The higher the onset potential, the higher is the oxygen reduction activity of the catalyst. As shown in FIG. 4, whereas Step-1 exhibited an onset potential of 0.3 V_{SHE} with respect to the standard hydrogen electrode, the heat-treated catalyst (Step-2) and the acid-treated catalyst (Step-3) exhibited higher onset potential of 0.8 V_{SHE}. This result demonstrates less overvoltage due to oxygen reduction, meaning that oxygen reduction activity was improved for the present material.

It is also demonstrated in FIG. 5 that the Co-ED/PPy-CNF catalyst of the Example (according to the present invention) has better oxygen reduction activity than the Co-ED/CNF catalyst of Comparative Example 1 (0.5 V_{SHE}) or the Co/PPy-CNF catalyst of Comparative Example 2 (0.6 V_{SHE}).

2) Evaluation of Single-Cell Oxygen Consumption

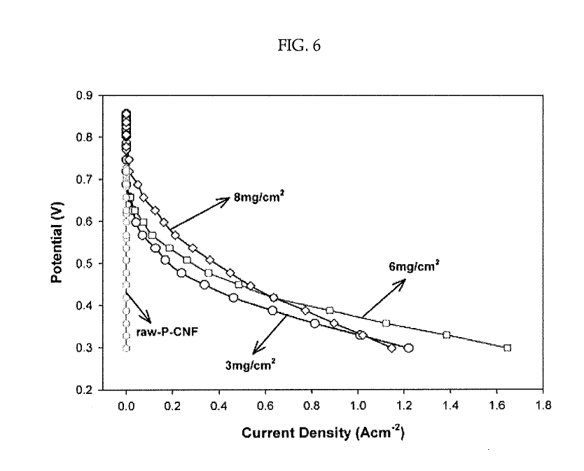

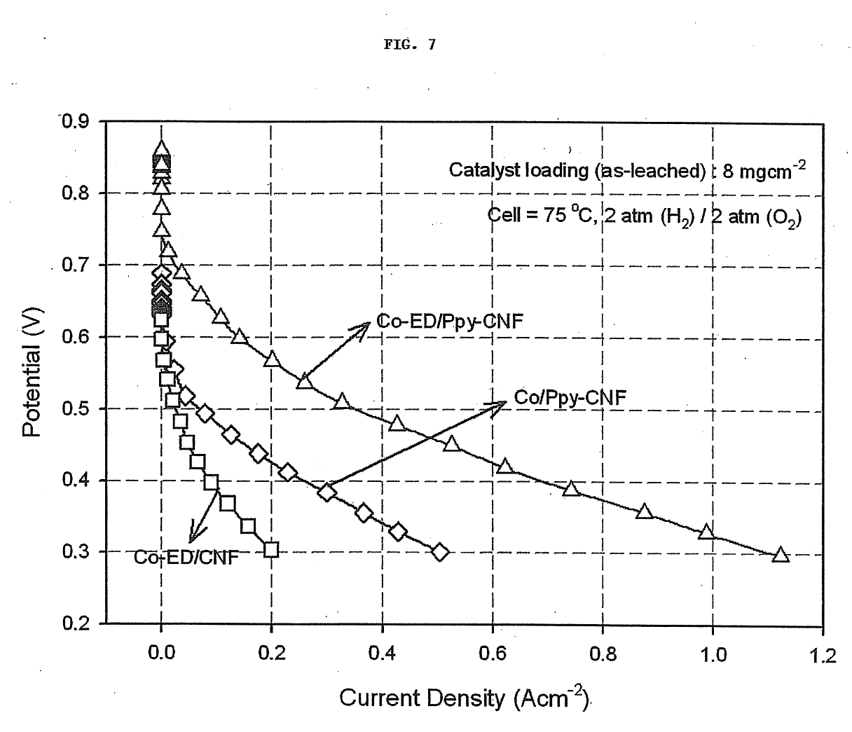

Electrodes were prepared using the Co-ED/PPy-CNF catalyst prepared in the Example (according to the present invention) with different coating amounts of 3, 6 and 8 mg/cm². While flowing hydrogen (300 ccm) to the anode and oxygen (600 ccm) to the cathode at a back pressure of 2 atm, single-cell oxygen consumption was measured at a cell temperature of 75° C. The result is shown in FIG. 6. Also, single-cell oxygen consumption of the catalysts prepared in Comparative Examples 1 and 2 was evaluated with the catalyst coating amount fixed at 8 mg/cm². The result is shown in FIG. 7.

As shown in FIG. 6, at 0.6 V, current density was 37 mA/cm² when the coating amount was 3 mg/cm². The current density was 75 mA/cm² and 162 mA/cm² respectively when the coating amount was 6 mg/cm² and 8 mg/cm². Although the highest current density was achieved at 0.6 V when the coating amount was largest with 8 mg/cm², the current density was the highest when the coating amount was 6 mg/cm² at 0.4 V, where the material transport is affected.

As shown in FIG. 7, current density of the Co-ED/CNF catalyst of Comparative Example 1 and the Co/PPy-CNF catalyst of Comparative Example 2 at 0.6 V was 4.2 mA/cm² and 8.4 mA/cm², respectively, which were much smaller than 162 mA/cm² of the Co-ED/PPy-CNF catalyst of the Example (according to the present invention). Considering that the single-cell performance of the cobalt-polypyrrole-carbon composite catalyst reported by Zelenay (Nature, Vol. 443, 63, 2006) was 120 mA/cm² at 0.6 V, the oxygen reduction catalyst of the present invention provides significantly superior single-cell performance.

3) Surface Analysis of Catalyst

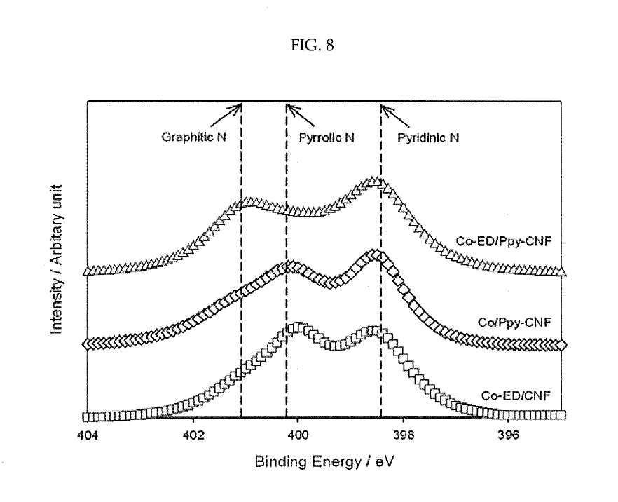

A N1s X-ray photoelectron spectroscopy (XPS) experiment was carried out in order to analyze the surface of the catalysts prepared in the Example and in Comparative Examples 1 and 2. The results are shown in FIG. 8 and Table 1.

TABLE 1

| | | XPS analysis (%) | | |
|---|---|---|---|---|
| | | Pyridinic | Pyrrolic | Graphitic |
| | Nitrogen content on | nitrogen | nitrogen | nitrogen |
| | catalyst surface (%) | (398.5 eV) | (400.1 eV) | (401.0 eV) |
| Example | 9.3 | 48.6 | 21.8 | 29.6 |
| (Co-ED/PPy- | | | | |
| CNF) | | | | |
| Comparative | 4.2 | 40.1 | 49.2 | 10.7 |
| Example 1 | | | | |
| (Co-ED/CNF) | | | | |
| Comparative | 6.3 | 46.3 | 35.5 | 18.2 |
| Example 2 | | | | |
| (Co/PPy-CNF) | | | | |

As shown in FIG. 8, three types of nitrogen, i.e., pyridinic, pyrrolic and graphitic, were identified through XPS. It is known that catalysts having good oxygen reduction activity have high nitrogen content on the surface and have high proportion of pyridinic and graphitic nitrogens. The Co-ED/PPy-CNF catalyst of the Example exhibited a surface nitrogen content of 9.3%, higher than the Co-ED/CNF catalyst of Comparative Example 1 (4.2%) and the Co/PPy-CNF catalyst of Comparative Example 2 (6.3%). Also, the Co-ED/PPy-CNF catalyst of the Example had the highest proportion of pyridinic and graphitic nitrogens. These result are in good agreement with the oxygen reduction activity and single-cell oxygen consumption evaluation results, and demonstrate that the method for preparing an oxygen reduction catalyst according to the present invention not only increases the nitrogen content on the catalyst surface, but also effectively increases the proportion of pyridinic and graphitic nitrogens. Further, it is expected that the Co-ED/PPy-CNF catalyst according to the present invention having the highest proportion of graphitic nitrogen (29.6%) will have superior catalyst durability.

4) Evaluation of Catalyst Durability

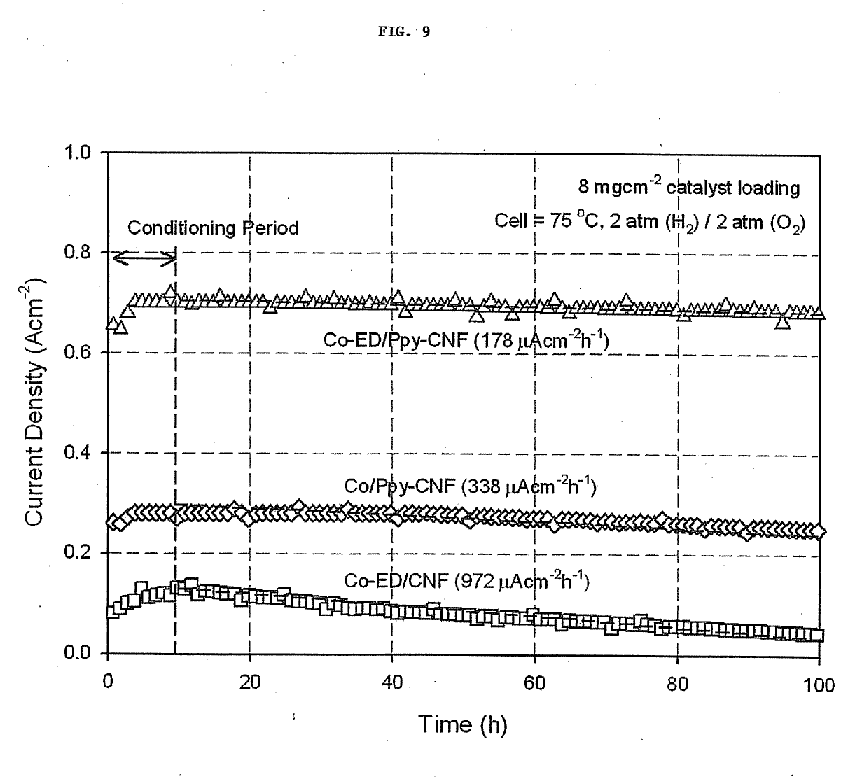

Electrodes were prepared with the catalyst coating amount fixed at 8 mg/cm² for evaluation of the durability of the Co-ED/PPy-CNF, Co-ED/CNF and Co/PPy-CNF catalysts prepared in the Example and in Comparative Examples 1 and 2. While flowing hydrogen (300 ccm) to the anode and oxygen (600 ccm) to the cathode at a back pressure of 2 atm, current density was measured for 100 hours in a constant-voltage mode of 0.4 V_{SHE}. The results are shown in FIG. 9.

Durability was evaluated based on the decrease of current density from 10 hours until 100 hours. A catalyst demonstrating smaller current density decrease is one having superior durability. As shown in FIG. 9, the Co-ED/PPy-CNF catalyst of the Example showed better durability with current density decrease by 178 μA/cm²·h as compared with the Co-ED/CNF catalyst of Comparative Example 1 (972 μA/cm²·h) or the Co/PPy-CNF catalyst of Comparative Example 2 (338 μA/cm²·h). This result is in good agreement with the proportion of graphitic nitrogen on the catalyst surface.

To conclude, with high proportion of pyridinic and graphitic nitrogens on the surface, the non-platinum oxygen reduction catalyst according to the present invention provides superior oxygen reduction activity and durability. Thus, it can be usefully applied to, for example, a polymer electrolyte membrane fuel cell.

Further, since the non-platinum oxygen reduction catalyst according to the present invention has superior catalyst durability in an acidic atmosphere because the carbon support is coated with the conductive polymer and has high oxygen reduction activity because the chelated cobalt is used, it can be usefully applied to, for example, a polymer electrolyte membrane fuel cell.

The present disclosure has been described in detail with reference to specific embodiments thereof. However, it will be appreciated by those skilled in the art that various changes and modifications may be made in these embodiments without departing from the principles and spirit of the disclosure, the scope of which is defined in the appended claims and their equivalents.

What is claimed is:

1. An oxygen reduction catalyst with chelated cobalt impregnated on a conductive polymer coated on a carbon support.

2. The oxygen reduction catalyst according to claim 1, wherein the carbon support is one or more selected from the group consisting of carbon black, carbon nanotube, carbon nanofiber, carbon nanocoil and carbon nanocage.

3. The oxygen reduction catalyst according to claim 1, wherein the conductive polymer is polypyrrole or polyaniline.

4. A method for preparing an oxygen reduction catalyst comprising:
adding a carbon support and 1-pyrenecarboxylic acid to ethanol to prepare a first mixture solution;
adding an oxidizing agent and pyrrole or aniline to the first mixture solution to prepare a carbon support coated with a conductive polymer;
adding a cobalt precursor and a chelating agent to ethanol to prepare a second mixture solution;
adding the carbon support coated with the conductive polymer to the second mixture solution to prepare an intermediate wherein chelated cobalt is impregnated on the conductive polymer;
heat treating the intermediate at 700 to 900° C.; and
treating the heat-treated intermediate with an acid.

5. The method for preparing an oxygen reduction catalyst according to claim 4, wherein the oxidizing agent is one or more selected from the group consisting of ammonium persulfate, iron(II) chloride and potassium dichromate.

6. The method for preparing an oxygen reduction catalyst according to claim 4, wherein the cobalt precursor is one or more selected from the group consisting of cobalt-containing oxide, acetate, nitrate and sulfate.

7. The method for preparing an oxygen reduction catalyst according to claim 4, wherein the chelating agent is ethylenediamine or 1,3-diaminopropane.
